(19) United States
(12) Patent Application Publication
(10) Pub. No.: US 2009/0084523 A1
(43) Pub. Date: Apr. 2, 2009

(54) HEAT EXCHANGER FOR VISCOUS FLUIDS

(76) Inventor: James Moir Cargill, (US)

Correspondence Address: JAMES MOIR CARGILL, 9 Lyngarth Park, 24 Lyngarth Rd, Kloof, 3610, omitted

(21) Appl. No.: 11/855,169

(22) Filed: Sep. 14, 2007

(51) Int. Cl. B01F 15/06; F28F 13/00

(52) U.S. Cl. 165/92; 165/94

(57) ABSTRACT

A vertical self-supporting heat exchanger for cooling or heating viscous liquids, especially for a sugar industry product known as massecuite, that has fixed and reciprocating vertical cooling or heating elements with attached scrapers or wipers that wipe the external surfaces of the elements to improve the heat transfer of the heat exchanger. The vertical reciprocating elements can be slowly moved through the viscous material by means of a hydraulic ram. The heat exchanger may have more than one pass if required.

### FIELD OF THE INVENTION

This invention relates to a heat exchanger apparatus for viscous fluids. Although this specification makes particular reference to the heating or cooling of sugar products, it must be understood that the invention also covers the heating or cooling of other viscous fluids.

### BACKGROUND OF THE INVENTION

In the process of making sugar, mixtures of sugar crystals and molasses have sometimes to be heated or cooled. This sugar and molasses mixture is known in the sugar manufacturing industry as ‘massecuite’. Massecuite is often very viscous and in the sugar manufacturing process is sometimes cooled so that the crystals can grow and more sucrose extracted from the molasses. After this process of crystallization has taken place, the massecuite may then have to be reheated in order to reduce its viscosity so that the next process, that of the separation of crystals from the molasses, can take place.

### SUMMARY OF THE INVENTION

The present invention is an apparatus that can both cool or reheat the very viscous crystal and molasses mixture called massecuite, or similar viscous fluids. Various apparatus and methods are known to cool or heat massecuites. Most of them consist of cylindrical or U-shaped vessels with rotating cooling or heating elements, or fixed elements with rotating arms that move the massecuite past the fixed elements in order to attain a heat transfer between the elements and the massecuite. The process can be batch or continuous. Where it is a batch process the vessel is filled and emptied after the desired processing of the massecuite has been reached. Where it is a continuous process the massecuite enters one end of the vessel and exits at the other. Several vessels can be connected in series in the continuous process. When the process is a cooling one the massecuite gets so viscous that the load on the rotating elements or arms becomes extremely high, and very robust, expensive and sophisticated rotational drives are employed to be able to rotate the elements in this viscous medium and attain a transfer of heat between the cooling elements and the massecuite. In addition, the transfer of heat between the massecuite and the elements depends on the flow of the massecuite past the surfaces of the elements, and, as the massecuite is very sticky and viscous, this makes the heat transfer slow and difficult.

It is an object of the invention to provide an apparatus for this difficult heat exchange duty to be simple, more effective and cheaper to manufacture than the present-day systems.

According to the invention there is provided a heat exchange apparatus comprising a vertically disposed vessel, usually cylindrical but not necessarily so, a means of feeding massecuite either near the top of the vessel or near the bottom of the vessel so that massecuite will travel vertically downwards or upwards in a continuous and controlled manner. The controlled flow path of the massecuite is achieved by division plates within the vessel that direct and guide the massecuite through compartments in a nearly plug-type flow through the height of the vessel and past fixed and moving cooling or heating elements. Vertical division plates can be fitted within the vessel to provide a multi-pass heat exchanger for the massecuite. The fixed and moving cooling or heating elements are fitted vertically in the vessel, and cold or hot water may be circulated through them depending on whether the massecuite is to be cooled or heated. The surfaces of the fixed and moving elements can be scraped or wiped by means of wipers which are attached to both the fixed and moving elements, thus removing the viscous massecuite and improving the heat transfer rate between the heating or cooling elements and the viscous material, massecuite. The moving elements rise and fall vertically alongside the fixed elements within the vessel by means of a hydraulic cylinder or ram, or a similar apparatus that will impart a reciprocating motion. The wipers that scrape or wipe clean the fixed elements are attached to the moving elements, and the wipers that scrape or wipe clean the moving elements are attached to the fixed elements. This wiping action removes and replaces massecuite adhering to the elements and greatly improves the heat transfer rate between the elements and the massecuite. The cross-sectional shape of the elements is tubular and can include any hollow cross-section, with or without fins, or any combination of these, but is not limited to these shapes. The vertical reciprocating motion to moving elements can be by means of a hydraulic cylinder and ram but is not limited to that device and other devices that can provide a reciprocating movement may be used.

### DESCRIPTION OF THE INVENTION

The invention will now be described by way of reference to the accompanying diagrammatic drawings.

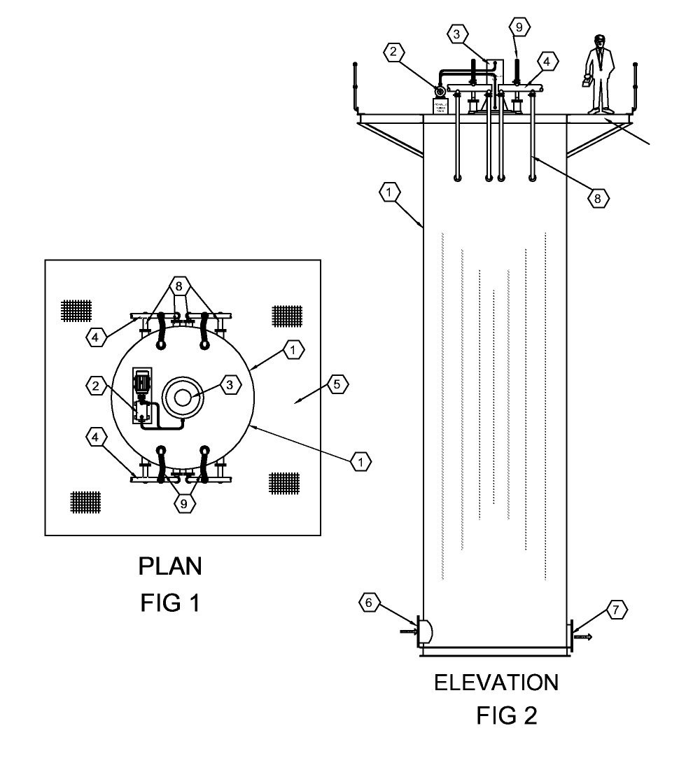

FIG. 1 shows an exterior elevation and plan of the heat exchanger.

FIG. 2 shows three views of the heat exchanger, a plan view, a vertical sectional view A-A through the heat exchanger, and a sectional plan view B-B.

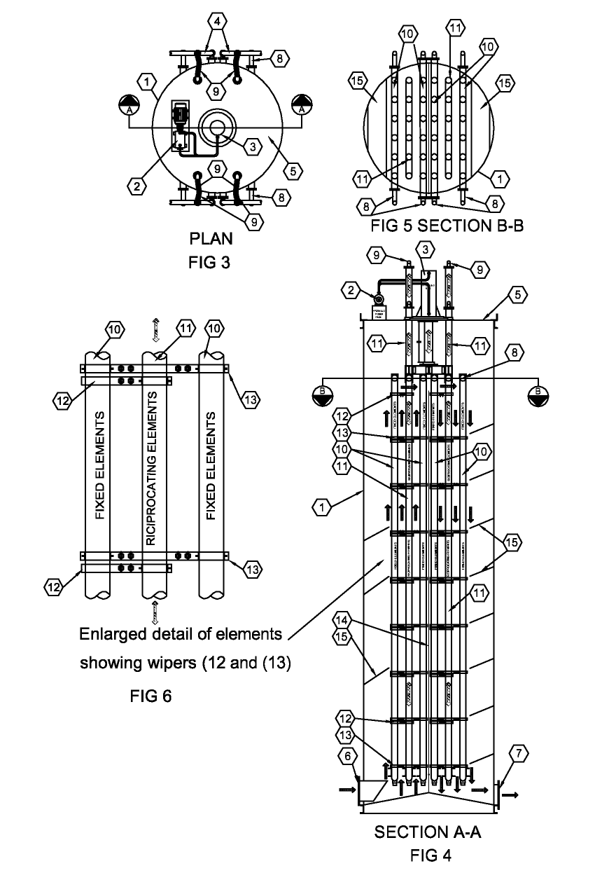

FIG. 3 shows a sectional elevation C-C and sectional plan D-D of a heat exchanger with a rectangular cross-section.

FIG. 4 shows details of wipers and elements.

Referring to Sheet 1/4, FIG. 1, this is an external plan view of the heat exchanger consisting of an outer cylindrical vertical fixed shell (1), a hydraulic power pack (2) that drives a reciprocating cylinder or ram (3), distribution headers (4) for the distribution of cooling or heating water to elements inside the vessel (1), an access and operating platform (5) rigid water pipe connections (8) to internal fixed vertical elements, and flexible water pipe connections (9) to internal vertical reciprocating elements. FIG. 2 is an external view of the heat exchanger showing an outer cylindrical vertical fixed shell (1), a hydraulic power pack (2) that drives a reciprocating cylinder or ram (3), distribution headers (4) for the distribution of cooling or heating water to elements inside the vessel (1), an access and operating platform (5) an inlet for massecuite (6), an outlet for massecuite (7), rigid water pipe connections (8) to internal fixed vertical elements, and flexible water pipe connections (9) to internal vertical reciprocating elements.

Referring to Sheet 2/4, FIG. 3, the plan view of the heat exchanger shows an outer cylindrical vertical fixed shell (1), a hydraulic power pack (2) that drives a reciprocating cylinder or ram (3), distribution headers (4) for the distribution of cooling or heating water to elements inside the vessel (1), an access and operating platform (5), rigid water pipe connections (8) to internal fixed vertical elements, and flexible water pipe connections (9) to internal vertical reciprocating elements. FIG. 4, Section A-A is a vertical sectional elevation through the heat exchanger showing an outer cylindrical vertical fixed shell (1), a hydraulic power pack (2) that drives a reciprocating cylinder or ram (3), an access and operating platform (5), rigid water pipe connections (8) to internal fixed vertical elements (10), and flexible water pipe connections (9) to internal reciprocating elements (11). The fixed vertical elements (10) consist of banks of elements parallel to one another but separated by banks of reciprocating elements in such a manner that there is always a fixed vertical element alongside a reciprocating element. Attached to the fixed elements are scrapers, or wipers (12) which remove massecuite from the surfaces of the nearby reciprocating elements. Conversely, attached to the reciprocating elements are scrapers, or wipers (13) which remove massecuite from the surfaces of the fixed elements. This wiping action enables an improvement in the heat transfer rate between the elements and the viscous massecuite which is slow moving and tends to cling to the surfaces of the elements thereby hindering the overall heat exchange of the apparatus. The fixed vertical plate (14) is a division plate creating a two-pass flow for the massecuite through the heat exchanger. If more passes are required more division plates can be fitted. This could be useful if cooling is required in the primary pass or passes in order to extract more sucrose from the massecuite by cooling, and then to reheat the massecuite in the secondary pass, or passes, so that the massecuite can be better handled in the following process of crystal separation by centrifugal machines. The diversion plates (15) divert the flow of massecuite towards the heat exchange elements where necessary to improve the plug flow of the massecuite through the heat exchanger elements. FIG. 6 gives enlarged details explaining how the scraper/wipers are attached to the fixed and reciprocating elements and the relationship between the fixed and reciprocating elements. FIG. 5 Section B-B is a horizontal section the through heat exchanger showing the banks of fixed elements (10) and the banks of reciprocating elements (11) inside the vessel.

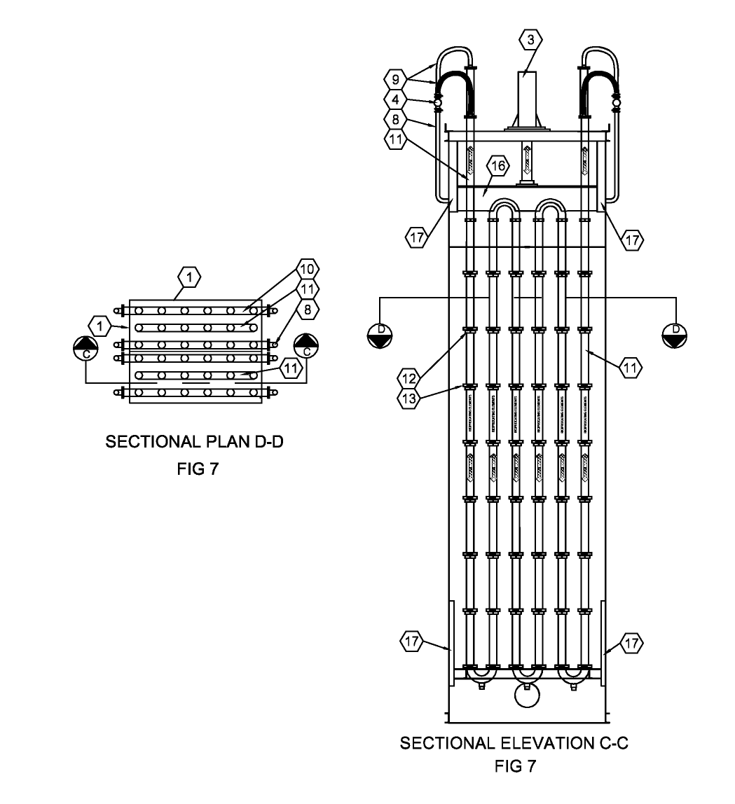

Referring to Sheet 3 of 4, FIGS. 7 and 8, show sections through a heat exchanger of rectangular section while Sheets 1 and 2 show sections of a heat exchanger of circular section. The rectangular section will give a better plug flow characteristic than that of a circular section as it is simpler to fill the space evenly with heat exchange elements. The outer shell (1) is made from flat plates to form a rectangular vertical box into which the fixed elements (10) and the reciprocating elements (11) are installed. The elements are connected to the distributing headers (4) by pipes (8) to the fixed elements and by flexible pipes (9) to the reciprocating elements. The reciprocating elements are wiped by scrapers or wipers (12) attached to the fixed elements, and the fixed elements are wiped by scrapers or wipers (13) attached to the reciprocating elements (11). The reciprocating elements are moved up and down by the hydraulic ram (3) attached to beams (16) and move in guides (17).

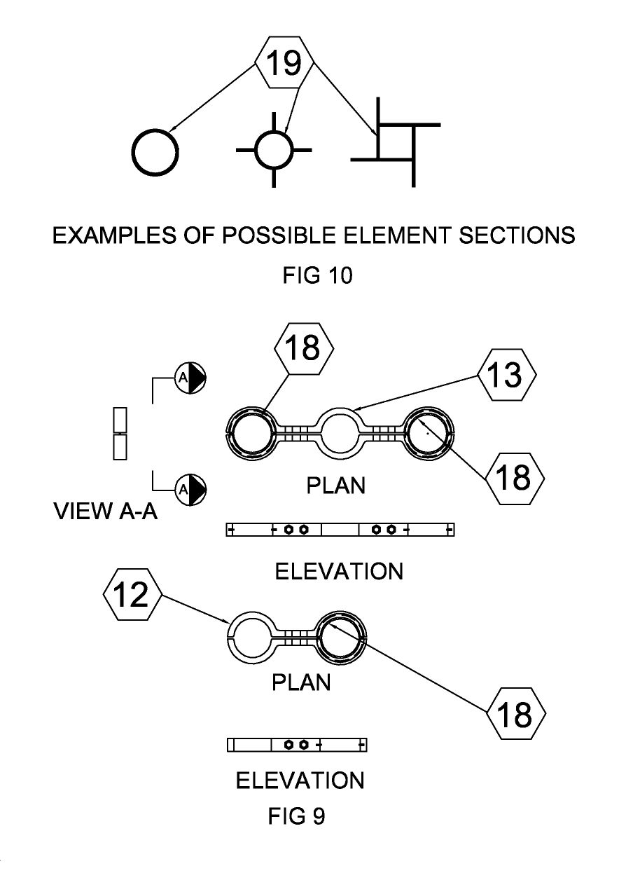

Referring to Sheet 4 of 4, FIG. 9, this shows various views of the scrapers or wipers (12) and (13) that are clamped to the fixed and moving elements. The clamping section has no wiping insert and just clamps the wiper to an element. The wiping section has a replaceable blade or insert (18) that is free to adjust slightly to any irregularity of the element being wiped and can be made of any suitable material that preferably has a self-lubricating property and will not wear down the surface of the element being wiped. Also shown in FIG. 10 are three examples of the possible sections through the hollow heat exchange elements (19) a plain circular tube or pipe, a circular tube or pipe with fins, and a square tube or pipe with fins. The plain circular tube or pipe is probably the easiest and simplest section to use but finned sections will give increased heating surface per unit length of element. For illustrative purposes the plain circular tube or pipe has been shown in the drawings as the heat exchange elements but other hollow sections with or without fins can be used.

The advantages of the invention over the existing equipment used for this duty are seen to be as follows:
1. The cooling or heating elements are not confined to one simple cross-sectional shape but can be, for example, round, square, rectangular or elliptical, with or without fins.
2. The movement of the viscous fluid past the surfaces of the elements is by means of wipers or scrapers attached to the fixed and reciprocating elements. Reciprocating elements are driven by a hydraulic ram or rams, thus avoiding the high torque requirements of present day heat exchangers that have rotational members for this function.
3. The hydraulic ram drive is cheaper than the rotational drive on present units.
4. The cooling or heating elements are wiped clean of the surrounding viscous fluid by the movement of the wipers or scrapers and this produces a better heat transfer rate between the elements and the viscous fluid.
5. The surface area of the heating or cooling elements can be varied to increase the surface area of the elements, for example, by the use of fins, yet still have the surfaces wiped of the viscous fluid.
6. A multi-pass configuration can be arranged which can improve plug flow of the massecuite.
7. A multi-pass configuration that can enable different temperature conditions to be obtained in each pass by varying the temperature of the heating or cooling liquid in the heat exchange elements.

1. A heat exchanger apparatus consisting of a vertical, self-supporting vessel inside of which are static fixed and moving reciprocating hollow elements of various cross-section through which hot or cold liquids, usually water, can pass and exchange heat between the elements and a surrounding viscous material, and fixed division plates that can impart a multi-pass flow for the viscous material.

2. A heat exchanger apparatus according to claim 1 in which scrapers, or wipers, are attached to the fixed and reciprocating elements that, due to the slow movement of the reciprocating elements, remove the viscous material from the outside surfaces of the elements thus improving the rate of heat transfer between the liquid inside the elements and the viscous liquid on the outside of the elements.

3. A heat exchanger apparatus according to claim 1 in which the reciprocating elements are moved slowly up and down by means of one or more hydraulic rams or cylinders, or other means, to impart a reciprocating movement to these elements.
